(19) United States
(12) Patent Application Publication
(10) Pub. No.: US 2002/0150227 A1
(43) Pub. Date: Oct. 17, 2002

(54) Operator-assisted on-line call alerting and call connection service

(76) Inventor: Simon Viruthakulangara Abraham, Bloomingdale, IL (US)

Correspondence Address: WALTER W. DUFT, LAW OFFICE OF WALTER W. DUFT, 10255 MAIN STREET, SUITE 10, CLARENCE, NY, 14031, US

(21) Appl. No.: 09/833,977

(22) Filed: Apr. 12, 2001

(51) Int. Cl. H04M 3/42

(52) U.S. Cl. 379/218.02; 379/215.01

(57) ABSTRACT

A system and method for providing communication assistance service based call alerting to an on-line data network user who has not pre-subscribed for automated data network call notification service, and connecting an incoming call at the on-line user's request. Initially, a Trunk Offering feature request or a call completion request to an on-line data network user is received at a voice network operator position system manned by either a live or automated communication assistance service entity, and which runs a service package application software program. The caller is prompted for caller information and a call alert charging strategy is established. The communication assistance service entity then requests that the on-line user be notified of the call request via the data network. After the online user is determined to be available for call alerting, the call alert charging strategy is implemented. The on-line user is prompted for a call handling action and the on-line user's response is collected and processed. If the response is to receive the voice network call connection, the on-line user is connected to the caller via an appropriate connection.

### BACKGROUND OF THE INVENTION

1. Field of the Invention

This invention relates to telecommunication systems for voice networks and data networks. More particularly, the invention concerns the sharing of automated and non-automated operator based network telephony services with on-line data network users.

2. Description of the Prior Art

Conventional telecommunication systems, such as the PSTN (Public Switched Telephone Network), support remote dial-up access to data networks, such as the public Internet or private corporate networks. Most subscribers of dial-up data network service remain on-line for long periods of time, and usually disable call waiting (assuming they have a pay subscription to such service) during on-line sessions.

Network operator assisted calling (hereinafter referred to as communication assistance) is used as the premium resource for voice network call completion and billing services throughout much of the world. Existing communication assistance services include customer emergency services such as call interruption service for voice connections (hereinafter referred to as Trunk Offering feature) which allows an operator to interrupt an existing voice connection (provided the line is marked intrudable) to advise the concerned party that someone is trying to place a high priority call to them. Although this service works well for voice connections, normal operator based Trunk Offering feature services are not available to notify an on-line data network user of an incoming call because the on-line user is not able to receive audible information via the in-service line connected to the user's modem.

Automated call notification service for on-line data network users (e.g., Internet call waiting) is available in some regions to provide notification of incoming telephone calls. This terminating switch-implemented service uses visual on-screen messages to provide call notification to on-line users, rather than audible information. However, a terminating number (called party) based intelligent switching system and a pay subscription are required.

It would be beneficial to allow PSTN callers to request that high priority call alerts be delivered to on-line data network users who are not subscribers to data network call notification service or who reside in regions where such service is not available. The ability to reach such on-line users through communication assistance service is particularly desirable insofar as such service does not require a terminating number based intelligent switching system. Nor does this service require pay subscriptions insofar as call alerts are normally paid for by callers on a per-call basis. Still more particularly, a caller should be able to reach an on-line data network user via a call alert without interrupting the user's on-line connection, and the on-line user should be permitted a choice of either accepting or rejecting the incoming call.

### SUMMARY OF THE INVENTION

The foregoing problems are solved and an advance in the art is obtained by a novel system and method for delivering call alerts via a communication assistance service entity to on-line data network users who have not pre-subscribed for data network call notification service, and connecting the calls with on-line user acceptance. By practicing the invention, new value-added services can be provided by telephone companies and/or Internet service providers to their subscribers and customers. These services can be extended to mobile telephone/terminal based data subscribers as well.

According to preferred embodiments of the invention, a Trunk Offering feature request or a call completion request is received at a voice network operator service position system managed by either a live or automated communication assistance service entity, and which runs a service package application software program. A billing strategy is established by the communication assistance service entity wherein the caller is notified of the charges that apply and the billing options are validated in advance of a call alert being sent to the on-line user. Billing scenarios include requesting the caller to provide a valid billing number, or deposit money if the caller is using a pay telephone. Alternatively, the caller could request that the called party be billed for both the call alert service and the call itself, in which case the call alert will advise the called party that the incoming call is a collect call. As part of call alert processing, the communication assistance service entity notifies a data network server resource of the call connection request, preferably via an intelligent network resource. The data network server resource then sends a call alert message to a data network client resource associated with the on-line user.

Prior to notifying the data network client resource of the call connection request, a determination is made as to whether the on-line user is actively on-line and may presently be reached via a call alert. This determination is performed by the data network server resource, which maintains a database of users who are actively on-line and properly authenticated. Note that the data network server resource could be incorporated into the intelligent network resource if such a configuration option is desired.

As part of call alert processing, the on-line user is advised of the incoming call and prompted for call handling instructions via an on-screen call alert message at the data network client resource. The on-line user's response is then collected and the data network client resource generates a call accept or call decline instruction and forwards it to the data network server resource. In turn, the data network server resource sends a call accept or call decline message to the communication assistance service entity, preferably via the intelligent network resource. If the call is accepted, the data network client resource drops the on-line user's data network connection and a voice connection is established between the caller and the on-line user. As an alternative, if the on-line user has VoIP capability and a relatively fast modem, the call could be connected via a data network gateway that interconnects the voice network and the data network, such that the on-line user's dial-up connection is maintained. If the call is rejected, or the on-line user is not able to receive call alerts, the caller is so advised. Note that other call handling options, such as directing the caller to a voice mailbox, or advising the caller that the on-line user will call back in a short time, could also be implemented.

### BRIEF DESCRIPTION OF THE DRAWING

The foregoing and other features and advantages of the invention will be apparent from the following more particular description of preferred embodiments of the invention, as illustrated in the accompanying Drawing, in which:

FIG. 1 is a functional block diagram showing a network architecture for a telecommunication system that provides intelligent personalized customer service in accordance with the invention;

FIG. 2A is a first portion of a flow diagram showing a series of method steps performed to implement the on-line subscriber alert service of the invention;

FIG. 2B is a first portion of a flow diagram showing a series of method steps performed to implement the on-line subscriber alert service of the invention; and

FIG. 3 is a diagrammatic illustration of an exemplary subscriber alert message.

### DETAILED DESCRIPTION OF THE PREFERRED EMBODIMENT

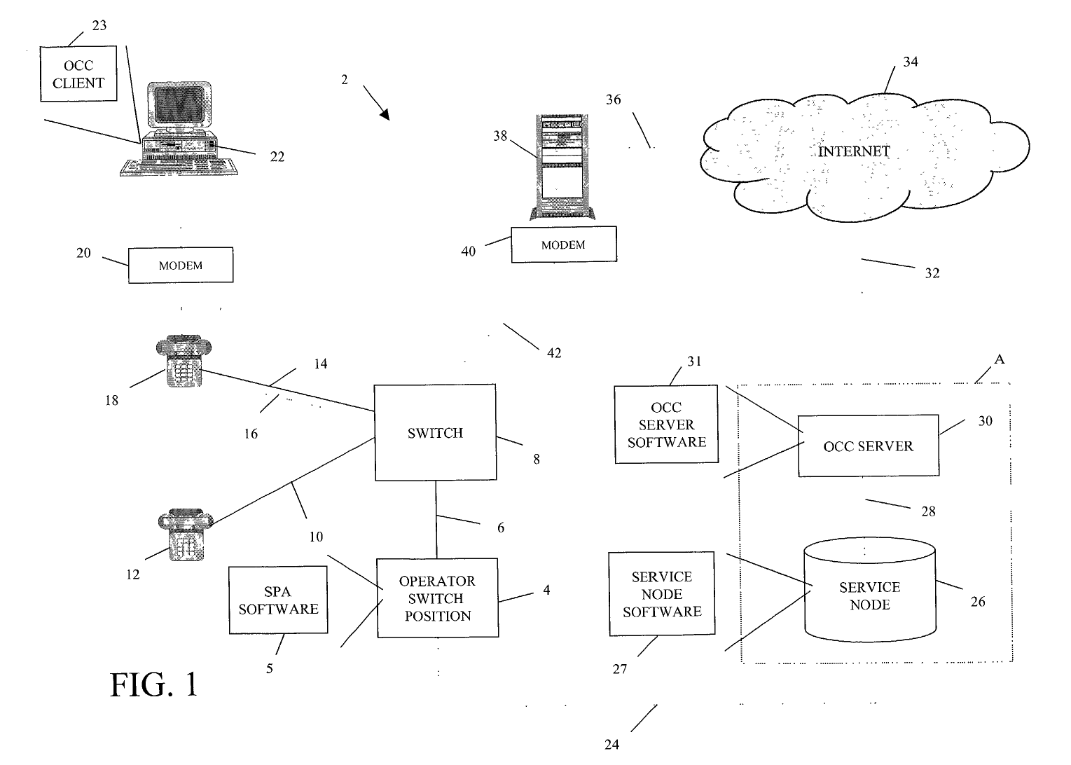

Turning now to the figures, wherein like reference numerals represent like elements in all of the several views, FIG. 1 illustrates a system 2 for implementing online subscriber call alerting and connection service in accordance with the invention. As will become apparent from the following description, the solid lines interconnecting various elements of the system 2 represent voice pathways, whereas the dotted lines represent data/signaling pathways.

The system 2 includes a voice network resource 4 that is preferably implemented at a tandem switch using an Operator Service Position System™ (OSPS) from Lucent Technologies, Inc., or any other suitable call handling system providing at least one operator switch position. In addition to its conventional ability to implement the above-described Trunk Offering feature, whereby an operator can interrupt an existing voice call upon caller request, this commercially available service platform is programmed or interfaced with a Service Package Application (SPA) 5 to perform data network call alerting functions according to the invention. In particular, the voice network resource 4 is adapted to allow a communication assistance service entity to implement the call alerting functions of the invention by requesting that call alerts be issued to on-line data network users who are not data network call notification subscribers.

The voice network resource 4 communicates via a voice pathway 6 with a conventional voice network switch 8. A signaling pathway (not shown) is also present between the voice network resource 4 and the switch 8 (and will typically share the same physical medium with the pathway 6, e.g., as an Integrated Services Digital Network (ISDN) link). The switch 8 can be implemented at a Central Office (CO) or any other suitable location. It connects via a voice pathway 10 to subscriber premises equipment 12, which is assumed to be a conventional voice telephone. The switch 8 also connects via a voice pathway 14 and a data pathway 16 (which will typically share the same physical medium) to subscriber premises equipment 18, which is also assumed to be a conventional voice telephone. A modem 20 allows a data network client resource 22, implemented as a personal computer, a mobile terminal or the like, to make network connections (e.g. using the Point-to-Point Protocol) through either the subscriber premises equipment 18 or directly to the data pathway 16. The data network client resource 22 runs OCC (On-line Communication Center) client software 23 (OCC Client) whose functions, which may be the same functions utilized for Internet call waiting, are described in more detail below.

The voice network resource 4 communicates via an intelligent network data pathway (e.g., ISDN, SS7) 24 to an intelligent network resource 26. The intelligent network resource 26 is a conventional intelligent network platform that can be implemented as a Service Node (SN) running Service Node software 27 to support conventional Internet call waiting service. Note that this platform could be independent of the switch 8, or could be integrated therewith. The intelligent network resource 26 conventionally includes one or more data storage resources (not shown) that allow the Service Node software 27 to implement a conventional Internet call waiting customer database administration function wherein subscribers of such service are validated/registered when they initially subscribe for service. This validation/registration information is typically used to identify Internet call waiting subscribers for billing purposes, and may also be used in accordance with the present invention for on-line user identification purposes, even though the on-line users will normally not be billed and need not be subscribers of Internet call waiting service.

Thus, when an on-line user first installs the OCC client software 23 and goes on-line, the client software can register the on-line user with the Service Node software 27, which may permit a static entry to be added for the on-line user in its Internet call waiting service customer database. The customer database can then be checked whenever a call alert service request is received at the intelligent network resource 26 from the voice network resource 4, just as it is checked when a switch issues a conventional Internet call waiting terminating attempt trigger query. However, because the Service Node software 27 knows the request is generated by the SPA software 5, and not a switch, it will handle the request even though the online user is not an Internet call waiting subscriber. In particular, the Service Node software 27 will perform subscriber verification, but not billing verification, of the on-line user. This subscriber verification step can be used to expedite call alert processing. If the on-line user is not in the Service Node software's customer database, the SPA software 5 is notified and call alert processing terminates. Only if the on-line user is found in the Service Node software's customer database, indicating that the on-line user has installed the required software, will call alert processing be allowed to continue.

As an alternative to the foregoing, the invention could be implemented without using the Internet call waiting service customer database of the intelligent network resource 26. In that case, when the intelligent network resource 27 receives a call alert service request from the voice network resource 4, the Service Node software 27 will simply bypass the usual query of its Internet call waiting customer database, performing neither billing verification nor subscriber verification.

The intelligent network resource 26 provides an interface between the voice network resource 4 and (via a data pathway 28) a data network server resource 30. The data network server resource 30 can be programmed with conventional OCC server software 31 that allows it to process call alert queries from the intelligent network resource 26 (see below) and issue Internet call waiting alerts to on-line data network users. It includes an active user database resource (not shown) that conventionally maintains a list of users who are actively on-line and properly authenticated for Internet call waiting service. On-line users who are eligible to receive call alerting service in accordance with the invention (by virtue of being online) will also be registered in this database. Note that the Service Node software 27 and the OCC server software 31 may both be supported by a single platform entity, as shown by the dashed line labeled “A” in FIG. 1. Indeed, the Lucent Technologies, Inc. OCC Internet call waiting server, which can be used to provide the OCC server of the present invention, is co-located with a conventional intelligent network Service Node. The Service Node software 27 and the OCC service software 31 may likewise share a single database that includes both the OCC subscriber information and the active user information referred to above.

The data network server resource 30 connects via a data pathway 32 to a data network, such as the Internet 34. Another data pathway 36 provides a connection from the Internet 34 to an ISP Remote Access Server (RAS) host 38. The ISP host 38 includes a modem pool that comprises multiple modems, one of which is shown at reference numeral 40. The modem 40 connects to the switch 8 via a data pathway 42.

It should be noted at this point that the terms “On-Line Communication Center” and “OCC” are designations used in connection with existing Internet call waiting products from Lucent Technologies, Inc. These terms are also used as descriptors herein to reflect that preferred embodiments of the invention can be implemented using Lucent's existing Internet call waiting product offerings. In particular, the OCC server software 31, the OCC client software 23, and the Service Node software 27 may all be used to implement the call alerting functions described herein. The only required modification is to the Service Node software 27, which if implemented in accordance with the invention, needs to be adapted to initiate call alert queries to the data network server resource 30 even when the on-line user does not appear as an Internet call waiting subscriber in the Service Node's customer database, or is listed therein but is not validated for billing purposes.

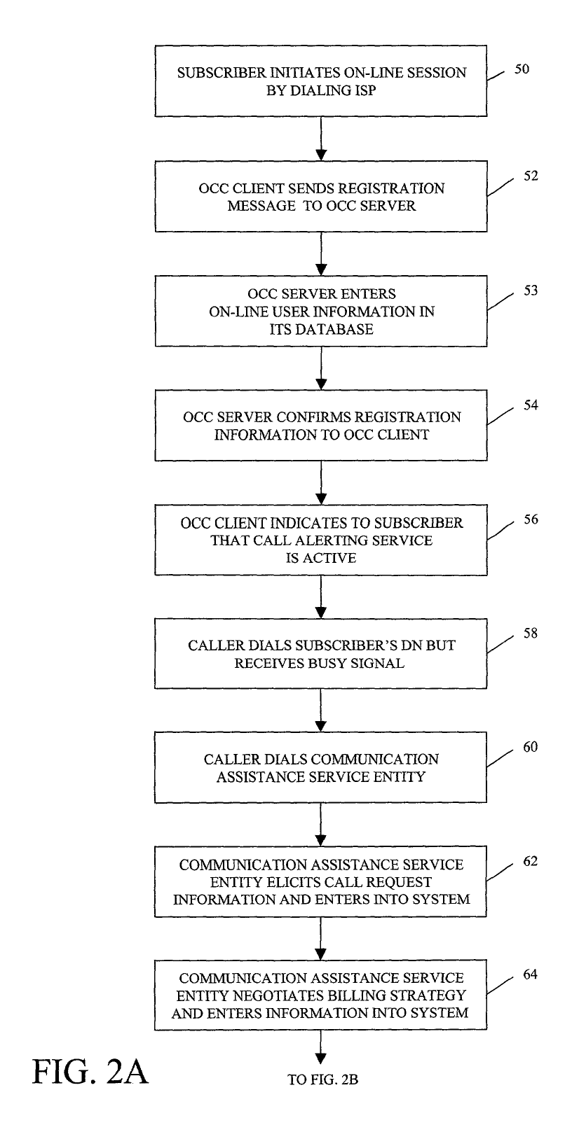

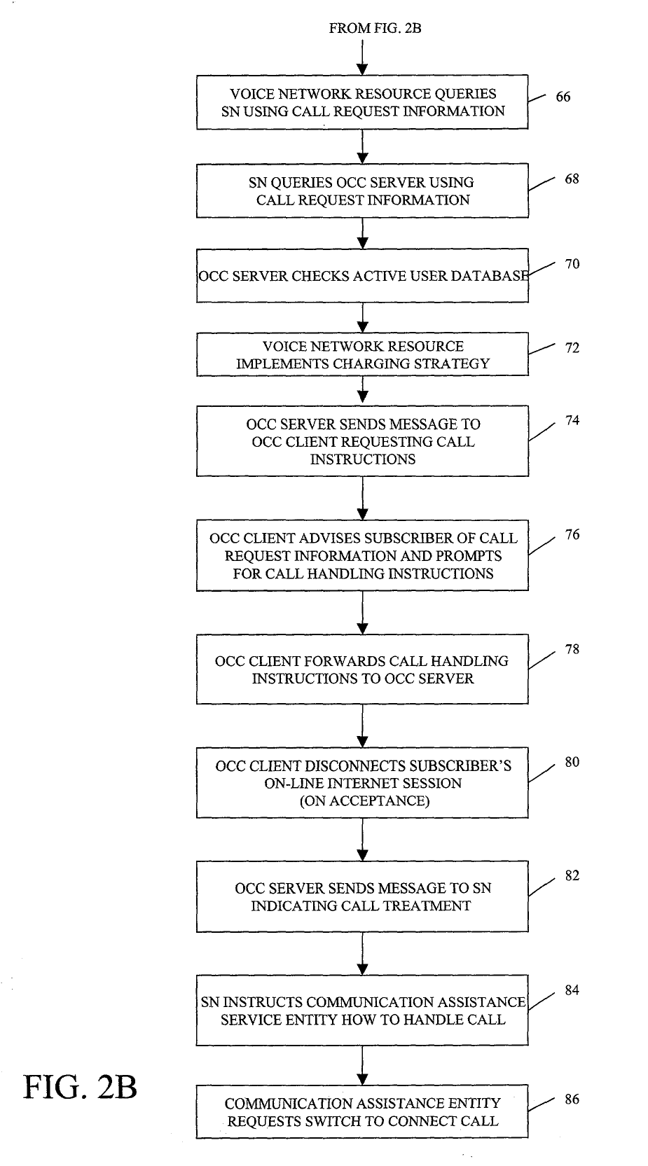

Turning now to FIGS. 2A and 2B, a description of an exemplary data network session and call scenario will serve to illustrate the operation of the invention. In a first step 50 of FIG. 2A, an on-line user operating the data network client resource 22 initiates a dial-up on-line session with the ISP host 38. In step 52, the OCC client software 23 running on the data network client resource 22 sends a registration message to the OCC server software 31 operating on the data network server resource 30 to indicate availability for call alerting service. Note that the OCC client software 23 could be a stand-alone application running in conjunction with a web browser, or if the data network client resource 22 is a mobile terminal, a micro-browser. Alternatively, the OCC client software 23 could be incorporated into a web browser or micro browser as part of the functionality thereof.

In step 53, the OCC server software 31 acts in response to the registration message sent by the OCC client software 23 by performing a conventional Internet call waiting registration function wherein it stores in its active user database a dynamic entry that indicates the on-line user is actively on-line and capable of receiving call alerts. The registration information that is stored in the active user database will preferably include the on-line user's DN (Directory Number), IP (Internet Protocol) address, a time stamp, and perhaps other information such as name and post office address. In step 54, the OCC server software 31 confirms the registration information to the OCC client software 23. In step 56, the OCC client software indicates to the subscriber, via an on-screen message, an audio message, or other suitable indicator, that call alerting service is active.

Note that the foregoing and all other communications between the OCC server software 31 and OCC client software 23 can be performed using any suitable high level data network protocol, such as H.323 or SIP (Session Initiation Protocol). Note, moreover, that each of the foregoing steps 50-56 are conventionally performed as part of Internet call waiting service.

In step 58, a caller operating the subscriber premises equipment 12 is assumed to dial the DN of the on-line user engaged in the above-described on-line session. Because the on-line user's telephone line is tied up by the modem 20, the dial attempt results in a busy signal. In step 60, the caller dials a DN associated with the voice network resource 4 and is connected to a communication assistance service position (for live assistance) or node (for automated assistance). In step 62, the communication assistance service entity prompts for and collects the on-line user's DN, and basic caller identification information such as the caller's name, telephone number, and perhaps a brief message. This information, which shall be hereinafter referred to as call request information, is input to the SPA software 5 running on the voice network resource 4.

Because the invention contemplates that the caller will normally be billed for issuing the call alert, rather than the on-line user, the communication assistance service entity will also advise the caller of the amount they will be billed and ask for a valid billing number, or request the caller to deposit money if the call is from a public telephone. In the alternative, if the caller indicates they do not wish to pay for the call alert, or the call itself, and instead desires the called party to pay, collect call billing could be selected. The foregoing interaction may be referred to as establishing a call alert charging strategy, and is shown by step 64 in FIG. 2A. The call alert charging information derived from this interaction is input to the SPA software 5 running on the voice network resource 4. If necessary, the billing option specified by the caller (e.g., charge the caller's home telephone number) is validated.

In step 66, shown in FIG. 2B, the SPA software 5 generates a call alert request message containing the call request information, and sends this message to the intelligent network resource 26 for processing by the Service Node software 27. This can be in the form of an ISDN message, a TCP/IP message, or a message based on any other suitable protocol. Note that the call alert request message will be formatted to identify the source of the message as the SPA software 5 rather than a conventional switch issuing an Internet call waiting terminating attempt trigger query. In that way, the Service Node software 27 will know to issue a call alert query to the OCC server software 31 even though the on-line user is not an Internet call waiting subscriber.

In step 68, and as described above, the Service Node software 27 may check its customer database to verify that there is an entry corresponding to the on-line user. If the on-line user is found in the customer database, the Service Node software will send a call alert query to the OCC server software 31 at the data network server resource 30. If the on-line user is not found in the customer database, the SPA software 5 is so notified, a short message is given to the caller to advise that the online user is unavailable, and the call alert procedure terminates.

Note that in implementations of the invention where the Service Node software 27 does not check its customer database relative to call alert request messages generated by the SPA software 5, step 68 will simply include the Service Node software issuing the call alert query to the OCC server software 31.

In step 70 of FIG. 2B, the OCC server software 31 checks its active user database to verify that the on-line user is available to receive call alerts and to locate the user in the data network via his or her IP address. If a check of the active user database does not find the on-line user, the caller is so advised and call alert processing terminates. If the on-line user is found in the active user database, then the SPA software 5 can now implement a charging strategy according to the charging information previously provided by the caller during step 64. This is shown in step 72 of FIG. 2B. Step 72 may thus include the SPA software 5 issuing a request to a voice network operations system (not shown) to apply a call alert service charge to the caller's telephone service account. Alternatively, if the charging strategy involves a pay telephone, the caller may be requested to deposit the required amount. If a collect call charging strategy was requested, a collect call request can now be sent to the on-line user (as part of the call alert).

In step 74, the OCC server software 31 generates a call alert message and sends it to the OCC client software 23 running on the data network client resource 22. This message includes the above-described call request information obtained during step 62. In addition, if a collect call charging strategy was previously selected by the caller, the call alert message will include appropriate collect call request information, as indicated above.

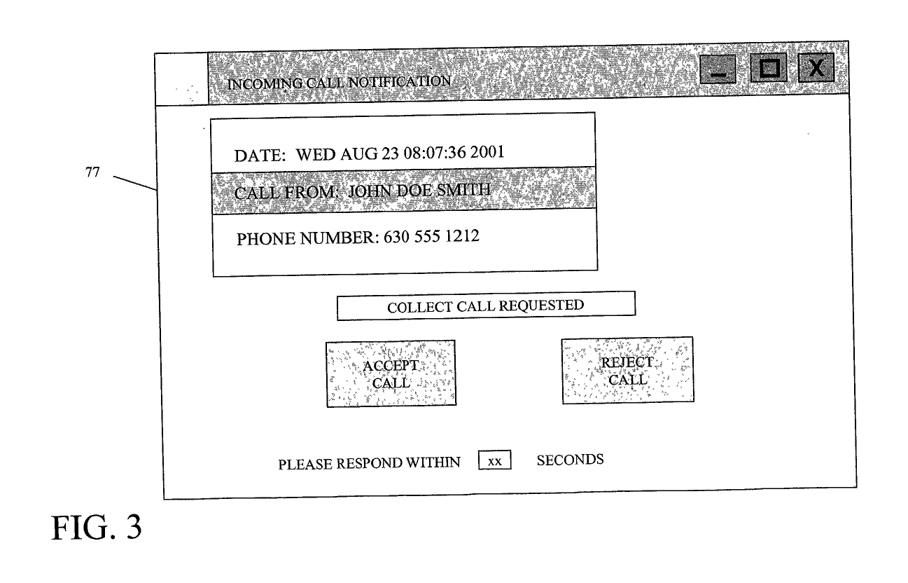

In step 76, the OCC client software 23 receives the call alert message, advises the on-line user of the information contained therein and prompts him or her for call handling instructions. The call request information can be provided to the on-line user in a variety of ways, but preferably includes generating an on-screen message. An example of such a message (designated by reference numeral 77) is shown in FIG. 3. As illustrated, the caller's name and telephone number are displayed. Additionally, a short message (not shown) could also be displayed if provided by the caller. An indication that collect call treatment is being requested may also be displayed. Lastly, one more graphical user interface elements (e.g., “Accept Call” or “Reject Call”) may be displayed to allow the subscriber to provide instructions for handling the call.

In step 78, the OCC client software 23 collects the on-line user's call handling instructions and begins response processing by sending the instructions to the OCC server software 31. In step 80, if the on-line user has elected to receive the call, the OCC client software 23 drops the on-line user's modem connection.

In step 82, the OCC server software 31 sends a message to the Service Node software 27 indicating how the call is to be treated. In step 82, the Service Node software 27 sends a message to the SPA software 5 advising how to handle the call. If the call is accepted, then in step 84, the switch 8 is requested (preferably via the communication assistance entity but perhaps alternatively by the servo node software 27 itself), to connect the caller to the on-line user. If the call is not accepted, or some other call treatment is indicated in the on-line user's response, the caller is advised accordingly.

Accordingly, a novel system and method for providing on-line call alerting and connection service have been disclosed. While various embodiments of the invention have been described, it should be apparent that many variations and alternative embodiments could be implemented in accordance with the invention. For example, the call alerting procedure could be implemented in a way that bypasses the intelligent network resource 26. In that case, the customer assistance service entity could query the OCC server software 31 (perhaps using a web browser or the like) to verify the on-line presence of the data network user. If the user is found, the SPA software 5 would forward the call request information directly to the OCC server software 31 to initiate call alerting. In a further modification of the invention, rather than disconnecting the on-line user from the data network when a voice call comes in, the voice call could be delivered as a VoIP call via an appropriate gateway interface between the voice network and the data network, assuming the on-line user has VoIP capability and a relatively fast modem connection. It is understood, therefore, that the invention is not to be in any way limited except in accordance with the spirit of the appended claims and their equivalents.

What is claimed is:

1. A method for providing communication assistance service based call alerting to an on-line data network user who has not pre-subscribed for automated data network call notification service, comprising the steps of:
receiving at a voice network resource managed by a communication assistance service entity a request from a caller in said voice network for establishment of a voice network call connection to said on-line user;
collecting call request information and establishing a call alert charging strategy relative to said caller;
notifying said on-line user of said call request via said data network;
prompting said on-line user for a call handling action;
collecting a response from said on-line user; and
processing said response such that if said response is to receive said voice network, call connection, said on-line user is connected to said caller.

2. A method in accordance with claim 1 wherein said receiving step includes receiving said call request at a voice network operator position system managed by a live communication assistance service entity and running a service package application software program.

3. A method in accordance with claim 1 wherein said receiving step includes receiving said call request at a voice network operator position system managed by an automated communication assistance service entity and running a service package application software program.

4. A method in accordance with claim 1 wherein said notifying step includes (a) said communication assistance service entity instructing a service package application program running on said voice network resource to issue a call alert request message containing said call request information, (b) a data network server resource being advised of said call alert request message, and (c) said data network server resource sending a call alert message to a data network client resource associated with said on-line user.

5. A method in accordance with claim 4 wherein said notifying step further includes said voice network resource sending said call alert request message to an intelligent network resource, and said intelligent network resource issuing a call alert query to said data network server resource.

6. A method in accordance with claim 5 wherein said notifying step further includes said voice network resource indicating to said intelligent network resource that said call alert request message is from said communication assistance service entity and said intelligent network resource issuing said call alert query without billing verification of said on-line user.

7. A method in accordance with claim 5 wherein said notifying step further includes said voice network resource indicating to said intelligent network resource that said call alert request message is from said communication assistance service entity and said intelligent network resource issuing said call alert query without subscriber verification of said on-line user.

8. A method in accordance with claim 4 wherein said notifying step further includes said data network server resource sending said call alert message to said data network client resource only upon said on-line user being verified by said data network server to be actively available for call alerting service.

9. A method in accordance with claim 1 wherein said call alert charging strategy is a caller charging strategy implemented prior to said notifying step being performed.

10. A method in accordance with claim 1 wherein said call alert charging strategy is a collect call charging strategy in which said on-line user is advised that collect call treatment is requested.

11. A system for providing communication assistance service based call alerting to an on-line data network user who has not pre-subscribed for automated data network call notification service, comprising:
a voice network operator position system operated by a communication assistance service entity and running a service package application software program;
a data network server resource in communication with said voice network operator position system;
said voice network operator position system being adapted to receive a request from a caller in said voice network for establishment of a voice network call connection to said on-line user;
said voice network operator position system being further adapted to receive call request information and call alert charging information input by said communication assistance entity;
said voice network operator position system being further adapted to provide notification of said request to said data network server resource, said notification including said call request information;
said data network server resource being adapted to send a call alert message to said on-line user and to receive an on-line user response;
said data network server resource being further adapted to provide notification of said response to said voice network operator position system;
said voice network operator position system being further adapted to implement a call alert charging strategy based on said call alert charging information prior to said data network server sending said call alert message to said on-line user; and
said voice network operator position system being further adapted to manage connection of said caller to said on-line user via said voice network upon said response being to receive said voice network call connection.

12. A system in accordance with claim 11 further including an intelligent network resource interconnecting said voice network operator position system and said data network server resource.

13. A system in accordance with claim 12 wherein said intelligent network resource is responsive to said voice network operator position system providing notification of said call request, and is adapted to notify said data network server resource of said call request without billing verification of said on-line user.

14. A system in accordance with claim 12 wherein said intelligent network resource is responsive to said voice network operator position system providing notification of said call request, and is adapted to notify said data network server resource of said call request without subscriber verification of said on-line user

15. A computer program product for providing communication assistance service based on-line call alerting to an on-line data network user who has not pre-subscribed for automated data network call notification service, comprising:
one or more data storage media;
program instruction means recorded on said media for:
delivering to a voice network communication assistance entity a request from a caller in said voice network for establishment of a voice network call connection to said on-line user;
receiving call request information and call alert charging information relative to said caller from said communication assistance service entity;
notifying said on-line user via said data network of said call request;
prompting said on-line user for a call handling action;
collecting a response from said on-line user; and
processing said response such that if said response is to receive said voice network call connection, said caller is connected to said on-line user via said voice network.

16. A program product in accordance with claim 15 wherein said delivery means and said receiving means are implemented at a voice network operator position system managed by a live communication assistance service entity and running a service package application software program that performs said receiving means.

17. A program product in accordance with claim 15 wherein said delivery means and said receiving means are implemented at a voice network operator position system managed by a live communication assistance service entity and running a service package application software program that performs said receiving means.

18. A program product in accordance with claim 15 wherein said notifying means is implemented at a voice network resource managed by said communication assistance service entity and at a data network server resource, and includes means in said voice network resource for generating a call alert request message containing said call request information and sending said call alert message for delivery of said call request information to said data network server resource, and means in said data network server resource for generating and sending a call alert message to a data network client resource associated with said on-line user.

19. A program product in accordance with claim 18 wherein said notifying means is further implemented at an intelligent network resource and includes means in said intelligent network resource for receiving said call alert request message from said voice network resource and issuing a call alert query to said data network server resource.

20. A program product in accordance with claim 19 wherein said notifying means further includes means in said voice network resource for forming said call alert request message to indicate to said intelligent network resource that said call alert request message is from said communication assistance service entity, and means in said intelligent network resource for issuing said call alert query without billing verification of said on-line user. .

21. A program product in accordance with claim 19 wherein said notifying means further includes means in said voice network resource for forming said call alert request message to indicate to said intelligent network resource that said call alert request message is from said communication assistance service entity, and means in said intelligent network resource for issuing said call alert query without subscriber verification of said on-line user.

22. A program product in accordance with claim 18 wherein said notifying means further includes means in said data network server resource for sending said call alert message to said data network client resource only upon said on-line user being verified to be actively available for call alerting service.

23. A program product in accordance with claim 15 further including means in said voice network resource for implementing said call alert charging strategy prior to said means for notifying said on-line user being implemented to provide said on-line user with said call request information.

24. A program product in accordance with claim 22 further including means in said voice network resource for implementing said call alert charging strategy as a collect call charging strategy.
